(19) United States
(12) Patent Application Publication
(10) Pub. No.: US 2016/0338154 A1
(43) Pub. Date: Nov. 17, 2016

(54) HIGH FREQUENCY DIELECTRIC HEATER

(71) Applicant: Takeshi NAGAHISA, Kanagawa (JP)

(72) Inventor: Takeshi NAGAHISA, Kanagawa (JP)

(21) Appl. No.: 15/142,477

(22) Filed: Apr. 29, 2016

(30) Foreign Application Priority Data
May 13, 2015 (JP) 2015-098181

(51) Int. Cl. H05B 6/54; H05B 6/62; H05B 6/60

(52) U.S. Cl. CPC H05B 6/54; H05B 6/60; H05B 6/62; B41J 11/002

(57) ABSTRACT

A high frequency dielectric heater includes a high frequency power supply configured to supply a power having a high frequency to heat a subject, electrodes including a positive electrode and a negative electrode, each electrode being disposed in such a manner that the longitudinal direction of each electrode crosses with the transfer direction of the subject and having a surface at least part of which is parallel to the subject, and a transfer device to transfer the subject.

### CROSS-REFERENCE TO RELATED APPLICATIONS

This patent application is based on and claims priority pursuant to 35 U.S.C. §119(a) to Japanese Patent Application No. 2015-098181 filed on May 13, 2015, in the Japan Patent Office, the entire disclosure of which is hereby incorporated by reference herein.

### BACKGROUND

1. Field of the Invention

The present invention relates to a high frequency dielectric heater.

2. Description of the Related Art

Some commercial inkjet printers, in particular, inkjet printers printing images on large-size posters or conducting gravure printing, include driers to dry the ink applied on recording media.

This type of drier employs methods using, for example, heated wind, a heat drum, infra red, or high frequency induced electricity. Of these, high frequency dielectric heating has less damage on a heated material, typically, paper than other drying methods.

### SUMMARY OF THE INVENTION

According to the present disclosure, provided is an improved high frequency dielectric heater which includes a high frequency power supply configured to supply a power having a high frequency to heat a subject, electrodes including a positive electrode and a negative electrode, each electrode being disposed in such a manner that the longitudinal direction of each electrode crosses with the transfer direction of the subject and having a surface at least part of which is parallel to the subject; and a transfer device to transfer the subject.

### BRIEF DESCRIPTION OF THE SEVERAL VIEWS OF THE DRAWINGS

Various other objects, features and attendant advantages of the present invention will be more fully appreciated as the same become better understood from the detailed description when considered in connection with the accompanying drawings, in which like reference characters designate like corresponding parts throughout and wherein

FIG. 1A is a diagram illustrating a high frequency dielectric heater according to a first embodiment of the present invention and FIG. 1B is a diagram illustrating a comparative example for explaining the first embodiment;

FIG. 2 is a graph illustrating the results of simulations of power applied to the water in the first embodiment of FIG. 1A and the comparative example of FIG. 1B;

FIGS. 3A and 3B are diagrams illustrating a high frequency dielectric heater according to a second embodiment of the present invention;

FIG. 4 is a graph illustrating applied power P in the second embodiment;

FIG. 5 is a graph illustrating simulation values of the power density in the second embodiment;

FIGS. 6A, 6B, and 6C are diagrams illustrating a high frequency dielectric heater according to a third embodiment of the present invention;

FIGS. 7A, 7B, and 7C are diagrams for explaining the principle of high frequency dielectric heating;

FIG. 8 is a diagram illustrating a configuration of the high frequency dielectric heater;

FIGS. 9A and 9B are diagrams illustrating the configuration of a drier; and

FIG. 10 is a diagram illustrating the equivalent circuit of the high frequency dielectric heater illustrated in FIG. 7 in further detail.

The accompanying drawings are intended to depict example embodiments of the present invention and should not be interpreted to limit the scope thereof. The accompanying drawings are not to be considered as drawn to scale unless explicitly noted.

### DESCRIPTION OF THE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

The high frequency dielectric heater relating to the present disclosure is described with reference to accompanying drawings

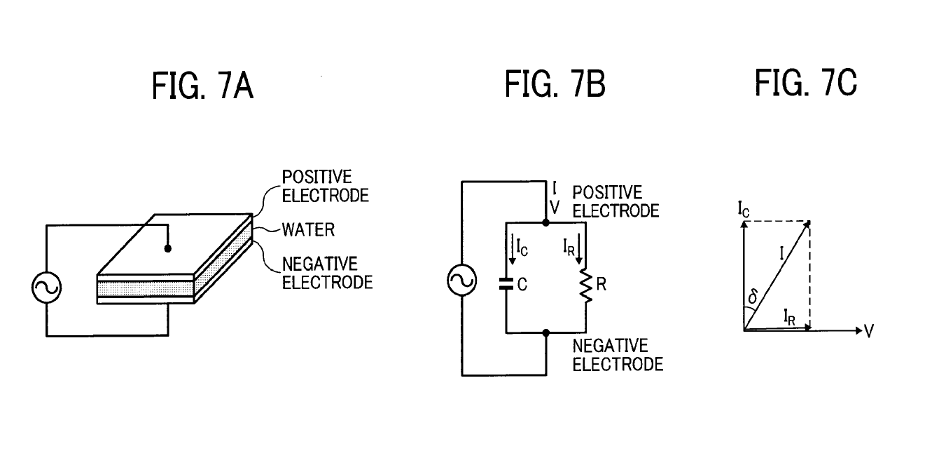

First, the principle of high frequency dielectric heating is described. FIG. 7 is a diagram for describing the principle of high frequency dielectric heating. FIG. 7A is a diagram illustrating the positional relation between the electrodes and water and FIG. 7B is a diagram representing an equivalent electric circuit of FIG. 7A. FIG. 7C is a graph illustrating the relation between the electric current Ic flowing into a capacitor C in FIG. 7B and a voltage V applied to the electrode.

As illustrated in FIG. 7A, in the high frequency dielectric heater, water is disposed between the positive electrode and the negative electrode and a high frequency bias is applied to the electrodes from the power supply. Water is a dielectric body so that a dipole of the molecule is formed when a high frequency electric field is applied to water. This dipole regularly rotates at a speed corresponding to the frequency applied. When a frequency having a certain value or higher is applied, the rotation of the dipole cannot keep up with the frequency of the high frequency power applied. Therefore, the dipoles collide each other, causing heat.

The amount of this heat generation P is known to be represented by the following relation 1.

$$\begin{matrix}Equation 1 & \\ P = ⌈ V \vert \vert {I}_{R} \vert = \vert V \vert \vert I \vert cos ( \frac{π}{2} - δ ) & ( 1 )\end{matrix}$$

In addition, the value of tanδ of the angle δ illustrated in FIG. 7C is known to have an inherent value to material as shown in the Equation 2.

$$\begin{matrix}Equation 2 & \\ tan δ = \frac{\vert {I}_{R} \vert}{\vert {I}_{C} \vert} = \frac{\vert V / R \vert}{\vert j ω CV \vert} 1 / ω CR & ( 2 )\end{matrix}$$

In this equation, j represents an imaginary number ((−1)^{1/2}) and ω represents an angle rate of high frequency power.

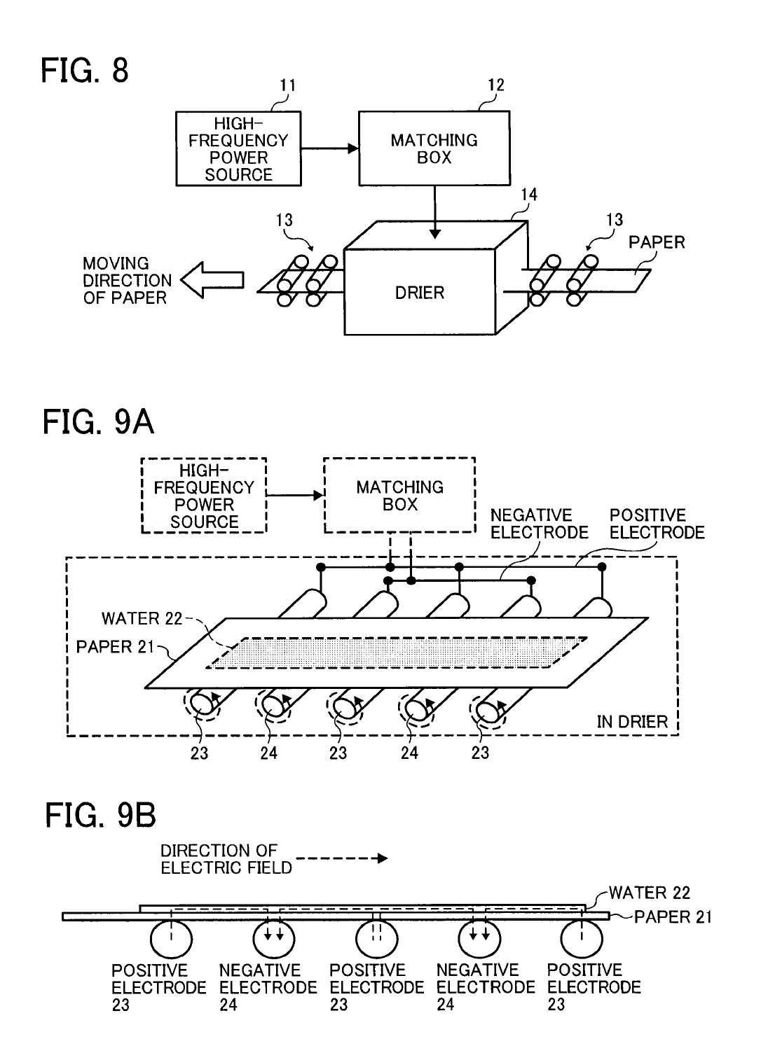

FIG. 8 is a diagram illustrating the configuration of the high frequency dielectric heater. As illustrated in FIG. 8, the high frequency dielectric heater includes a high frequency power source 11, a matching box 12, a transfer device 13, and a drier 14.

The high frequency dielectric power source 11 has a high frequency oscillator to supply a high frequency power of several MHz or greater.

The matching box 12 matches the impedance between the output terminal of the high frequency power source 11 and the input terminal of the drier 14. The transfer device 13 transfers a recording medium having an image thereon to the drier 14 and ejects the recording medium from the drier 14 after drying. The drier 14 evaporates moisture of the recording medium by high frequency dielectric heating.

FIGS. 9A and 9B (FIG. 9) are diagrams illustrating an example of the configuration of the drier 14. FIG. 9A is a perspective view of the main part of the drier 14 and FIG. 9B is a cross-sectional view taken from the transfer direction of FIG. 9A. As illustrated in FIGS. 9A and 9B, the drier 14 has multiple positive electrodes 23 and multiple negative electrodes 24, which are alternately arranged in such a manner that the axis direction of each electrode crosses with the transfer direction of the recording medium.

The electrical power line output from the positive electrode is toward the negative electrode via water 22 contained in paper 21 as the recording medium. An electric field is generated when the electrical power line enters into the water 22, resulting in high frequency dielectric heating.

The positive electrode 23 and the negative electrode 24 in a typical high frequency dielectric heater also serve as rollers to transfer the recording medium. Therefore, the positive electrode 23 and the negative electrode 24 have pillar-like forms. Therefore, the distance between the paper 21 as a heated material transferred in a planar manner and the surface of each electrode changes according to the position in the radial direction of the surface of each electrode, which causes an energy efficiency problem.

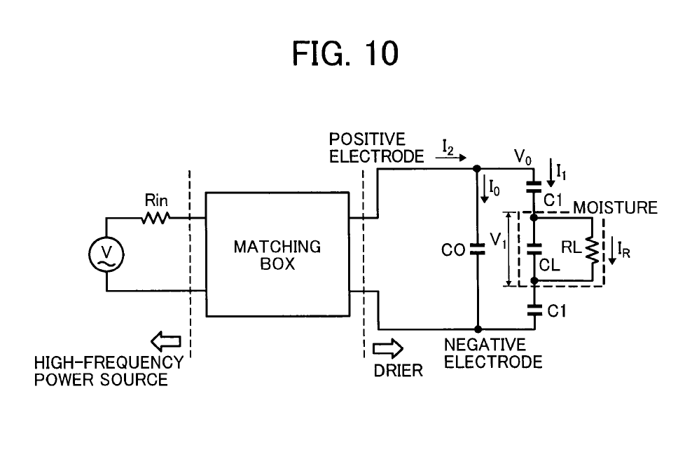

FIG. 10 is a diagram illustrating the equivalent circuit of the high frequency dielectric heater illustrated in FIG. 7 in further detail. As illustrated in FIG. 10, when water is placed between the positive electrode and the negative electrode, the equivalent circuit can be drawn, including a capacitor CO and a capacitor circuit connected to the capacitor C0 in parallel. This capacitor circuit can be drawn, including a capacitor CL, a resistance RL connected in parallel with the capacitor CL, and capacitors C1 individually connected to both ends of the capacitor CL. Of these, the capacitor CL and the resistance RL connected in parallel correspond to water. In addition, the capacitor C1 indicates the capacity of the space between the positive electrode and the water and the negative electrode and the water. The capacitor C0 indicates the capacity of the space between the positive electrode and the negative electrode. Rin represents an output impedance of the high frequency power supply.

First, the current flowing in the capacitor CL is represented by the following equation 3 when a high frequency voltage V0 is applied from the positive electrode and the negative electrode.

$$\begin{matrix}Equation 3 & \\ {I}_{1} = \frac{{V}_{0}}{\frac{2}{j ω {C}_{1}} + \frac{{R}_{L}}{1 + jω {C}_{L} {R}_{L}}} & ( 3 )\end{matrix}$$

In this equation, j represents an imaginary number ((−1)^{1/2}) and ω represents an angle rate of high frequency power.

Furthermore, a high frequency voltage V₁ applied to the water is represented by the following equation 4.

$$\begin{matrix}Equation 4 & \\ {V}_{1} = {I}_{1} ( \frac{{R}_{L}}{1 + jω {C}_{L} {R}_{L}} ) = \frac{jω {C}_{L} {R}_{L} {V}_{0}}{2 + jω {R}_{L} ( 2 {C}_{L} + {C}_{1} )} & ( 4 )\end{matrix}$$

The absolute value |V₁| of the high frequency voltage V₁ is represented by the following equation 5.

$$\begin{matrix}Equation 5 & \\ \vert {V}_{1} \vert = \frac{ω {R}_{L} \vert {V}_{0} \vert}{\frac{4}{{C}_{1}} + {ω}^{2} {{R}_{L}^{2} ( 2 \frac{{C}_{L}}{{C}_{1}} + 1 )}^{2}} & ( 5 )\end{matrix}$$

The power consumption P_{L} in the water is represented by the following equation 6 due to the equation 5 and the relation between RL and tanδ represented by the equation 2.

$$\begin{matrix}Equation 6 & \\ {P}_{L} = {\vert {V}_{1} \vert}^{2} / {R}_{L} = \frac{ω {C}_{L} tan δ {\vert {V}_{0} \vert}^{2}}{{[ \frac{4 {C}_{L}}{{C}_{1}} {C}_{L} {tan}^{2} δ + {( \frac{2 {C}_{L}}{{C}_{1}} + 1 )}^{2} ]}^{2}} & ( 6 )\end{matrix}$$

According to the equation 6, to increase the power consumption P_{L} in the water, it is necessary to decrease CL/C1, in other words, increase C1/CL.

In addition, a current flowing in C0 is represented by I₀. As a current I₁ flowing in C1 increases, the amount of power consumption P_{L} consumed at R_{L} increases. That is, the current I0 flowing in C0 can be reduced by decreasing the capacity of the capacitor C0. It is possible to increase the current I₁ and furthermore the amount of power consumption P_{L} consumed at R₁.

### FIRST EMBODIMENT

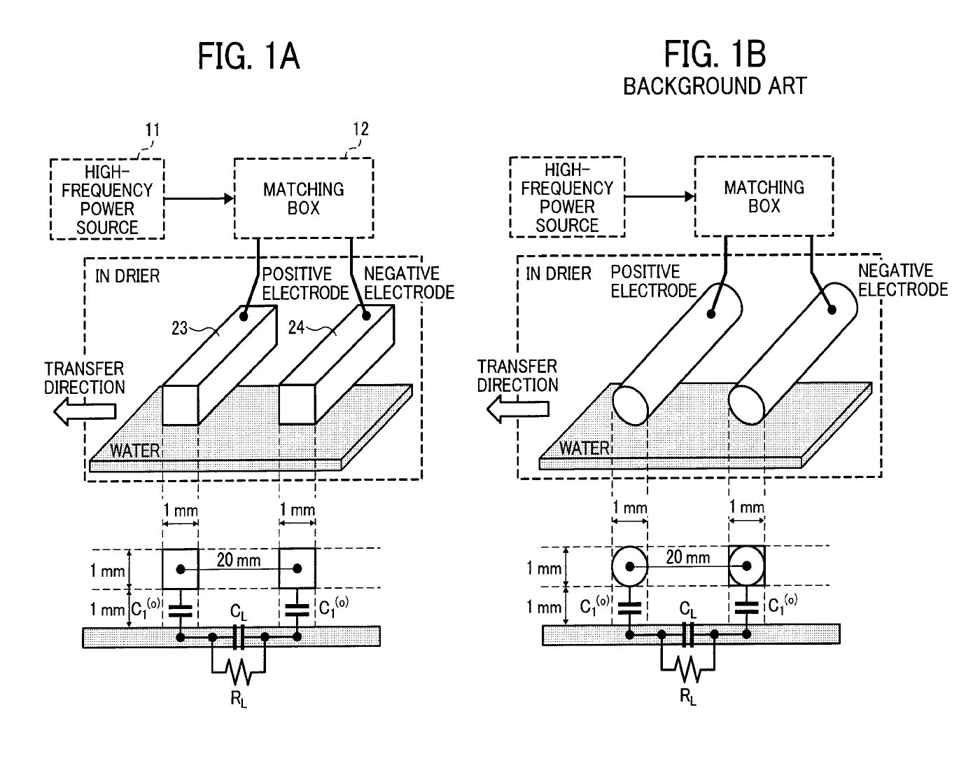

FIG. 1 is a diagram illustrating the first embodiment of the present disclosure. FIG. 1A illustrates a high frequency dielectric heater of the first embodiment and FIG. 1B illustrates a comparative example.

As illustrated in FIG. 1A, in the high frequency dielectric heater of this embodiment, the positive electrode and the negative electrode include a plane disposed in parallel with a subject to be heated (serving as a recording medium) and the longitudinal direction of the electrodes crosses with the transfer direction of the subject. Therefore, the distance between the electrodes and the recording medium containing moisture can be uniform and short in comparison with the case of a pillar-like form in which the cross section of the electrodes is circular. In addition, the positive electrode and the negative electrode are disposed on the same side relative to the subject to be heated. Unlike the typical technology, a transfer roller is provided separately from the electrodes in this embodiment. The transfer roller is omitted in the drawings.

The form of the electrode can be cuboid, semi-pillar, triangle pole, square pole having a cross section of trapezoid or parallelogram. Of these, a cuboid is preferable in terms of workability. Also, a chamfered cuboid is more preferable to prevent concentration of electric fields.

As an example, FIG. 1A illustrates a high frequency dielectric heater having a square pole having a cross section of 1 mm×1 mm to maintain the distance between the centers of the positive electrode and the negative electrode at a height of 1 mm vertically from the water.

In addition, FIG. 1B illustrates a high frequency dielectric heater as a comparative example having electrodes having a pillar-like form with the other conditions the same.

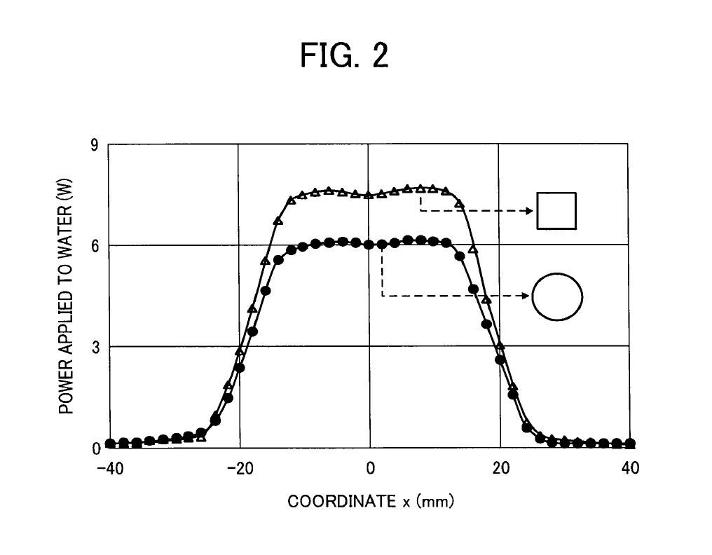

FIG. 2 is a graph illustrating the result of simulation of the power applied to the water in the case illustrated in FIG. 1 A and the case illustrated in FIG. 1B. In FIG. 2, the graph indicated by a symbol of square represents the first embodiment and the graph indicated by a symbol of circle represents the typical technology.

As illustrated in FIG. 2, in comparison with the comparative example case employing the typical technology, the high frequency dielectric heater of the first embodiment is capable of applying a greater amount of power to the water. This can be explained by the fact that the value of C1/CL is greater in this embodiment than the typical technology.

As described above, the high frequency dielectric heater of the present embodiment includes the electrode having a plane surface and the plane surface is disposed in parallel with a subject to be heated.

Therefore, the distance between each electrode and the subject can be made smaller, so that a greater amount of power can be applied to the subject, resulting in improvement of energy efficiency.

### SECOND EMBODIMENT

The high frequency dielectric heater of the second embodiment has the same configuration as the first embodiment except that the form of the electrodes is different.

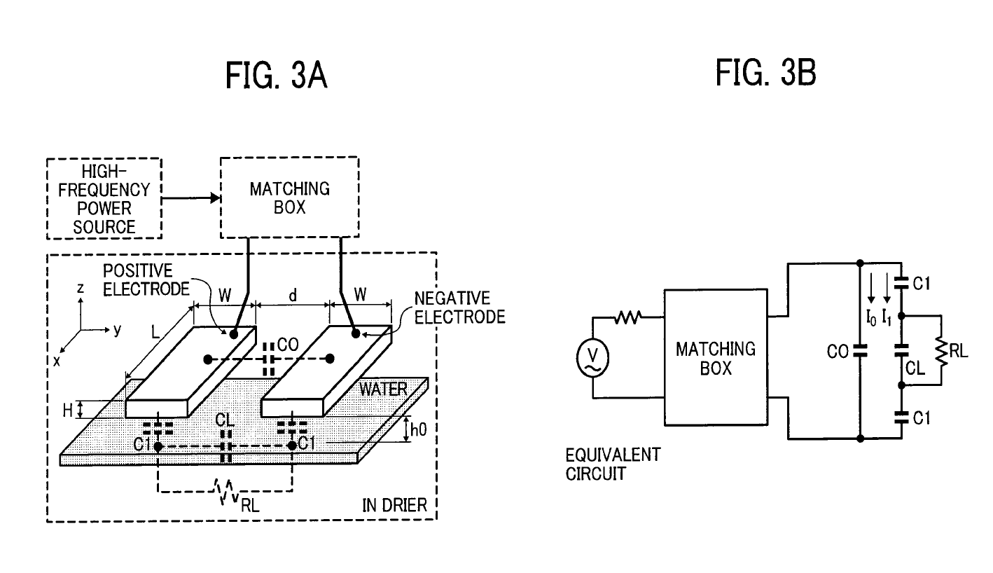

FIG. 3 is a diagram illustrating the configuration of the high frequency dielectric heater of the second embodiment. FIG. 3A is a perspective view and FIG. 3B is a diagram illustrating the equivalent circuit of the example illustrated in FIG. 3A.

In this embodiment, the electrode has a flat-plate like form having a pair of facing flat-plate surfaces having an area (first area) larger than the area (second area) of the other surfaces. Also, the flat-plate surface having the largest area of the surfaces constituting the electrode is disposed in parallel with the subject to be heated.

When the length (depth), the width, and the height of the flat-plate form electrode are respectively defined as L, W, and H, H is shorter than L and H is shorter than W.

In addition, the base of the electrode on the bottom side is disposed at a distance of h0 from the surface of the water. The distance between each electrode is maintained a distance d.

In FIG. 3B, C1 represents the capacity between the positive electrode and the water and the negative electrode and the water and C0 represents the capacity between the positive electrode and the negative electrode. The parallel circuit of CL and RL represents an equivalent circuit of the water as a dielectric body.

As the capacity of the positive electrode and the negative electrode decreases, namely, the distance between the positive electrode and the negative electrode increases, the current I₀ flowing into the capacitor C0 decreases and the current I₁ flowing into the capacitor C1 increases. That is, as the distance between the positive electrode and the negative electrode increases, the power applied to the water increases.

On the other hand, when the electrode width W of the positive electrode and the negative electrode is caused to increase, C1/CL increases, so that the power applied to the water increases.

The power density is defined by the following equation 7.

$$( Power density P\_d ) = ( Power applied to water ) / ( Area of electrode applying power ) = ( Power applied to water ) / ( ( 2 W + d ) \times L ) \qquad Equation 7$$

L and H of the positive electrode and the negative electrode are determined taking into account the restrictions of the device. Accordingly, it is necessary to calculate the value of W to make the power density P_d maximum from a designing point of view.

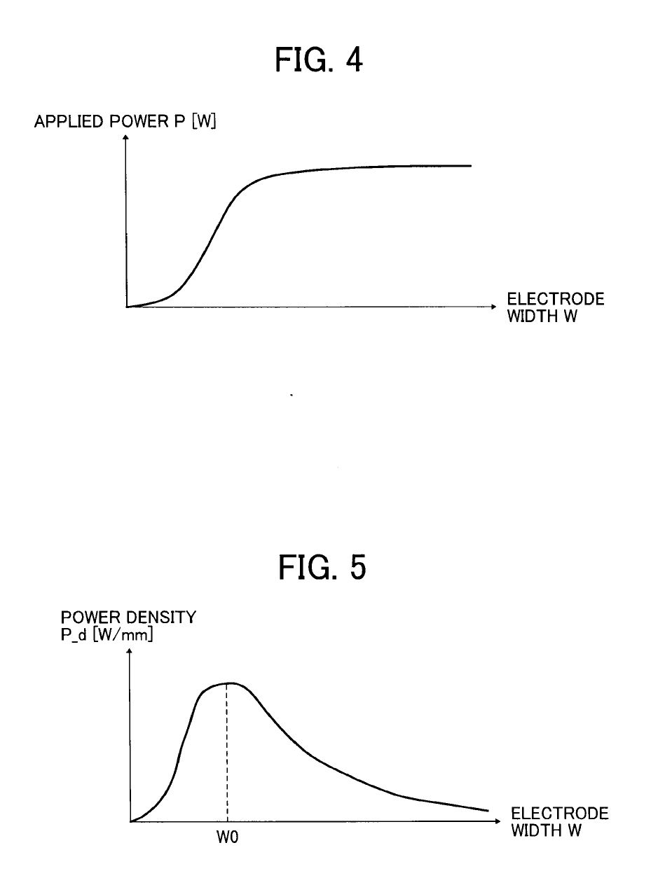

FIG. 4 is a graph illustrating the power P applied and FIG. 5 is a graph illustrating the simulation values of the power density P_d in the second embodiment. In the graph of FIG. 4, the value of the width W of the electrode and the power P (W) applied to the water are shown as the distance d between the electrodes are kept equal.

In FIG. 4, as the width W increases, the value of C1/CL increases, so that power applied to the eater increases. Therefore, the curve of the power amount P applied increases to the width W of the electrode.

FIG. 5 is a graph illustrating the result of the calculation of the power density according to the equation 7. For the width W having a certain value, although the increase rate of the power applied to the width W decreases, it increases in a linear manner to the value of the denominator of the equation of the power density P_d and the area to which the power is applied. Therefore, the graph of the power density P_d has a local maximum point to the width W of the electrode. The value of the width W is defined as W0 when the power density P_d is the local maximum point. The width W is set to be equal to W0.

As described above, the high frequency dielectric heater of the present embodiment includes the electrode having a flat plate-like form and the plane surface having the maximum area is disposed in parallel with a subject to be heated.

Therefore, the energy efficiency is improved.

### THIRD EMBODIMENT

The high frequency dielectric heater of the present embodiment has the same configuration as the second embodiment except that the electrodes sandwich the subject to be heated and the electrodes are spaced the distance d therebetween from the facing positions of the electrodes.

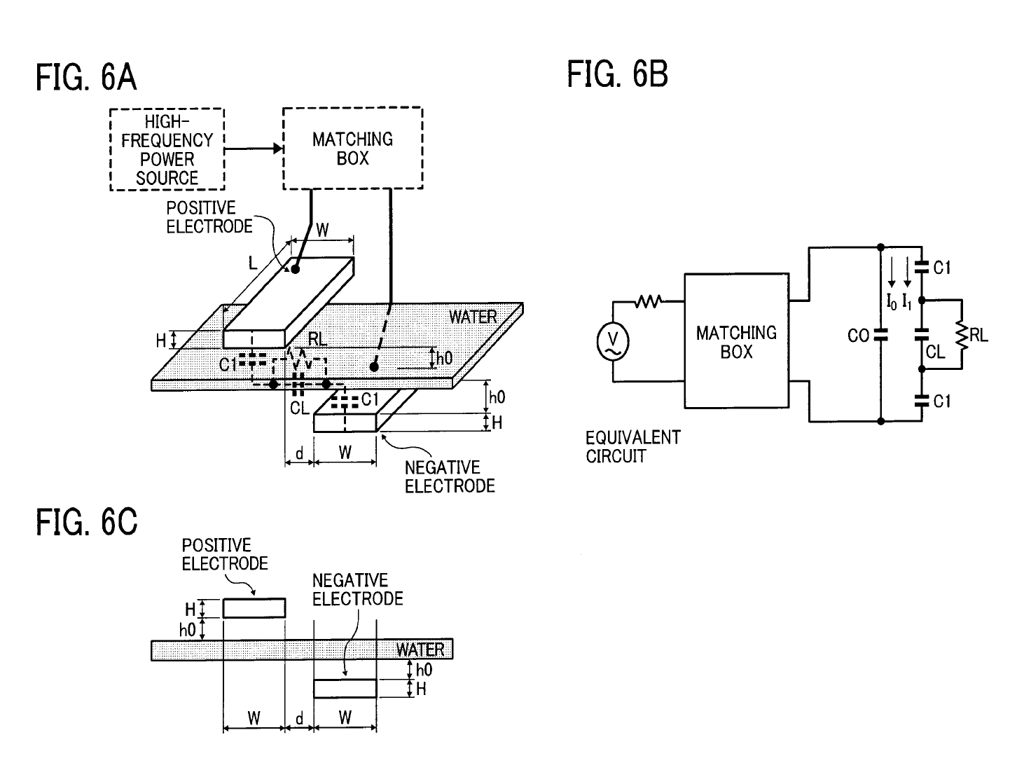

FIGS. 6A and 6B (FIG. 6) are diagrams illustrating the high frequency dielectric heater of the third embodiment. FIG. 6A is a perspective view of the high frequency dielectric heater. In addition, FIG. 6C is a cross section of the high frequency dielectric heater illustrated in FIG. 6A. As illustrated in FIGS. 6A and 6B, the positive electrode and the negative electrode sandwich the subject to be heated, i.e., the water, and are disposed above and under. In addition, the form of the electrodes is cuboid having a flat-plate like form. When the length, the width, and the height of the electrode are respectively defined as L, W, and H, H is shorter than L and H is shorter than W.

In addition, both the positive electrode and the negative electrode are disposed at the position of the height h0 in the vertical direction from the water and the distance d between the electrodes in the horizontal direction is 0 or greater.

FIG. 6B is a diagram illustrating the equivalent circuit of the example illustrated in FIG. 6A. As illustrated in FIG. 6B, unlike the second embodiment, since the water is sandwiched between the positive electrode and the negative electrode, the capacity C0 between the positive electrode and the negative electrode is extremely small in comparison with C1 and CL. Like the second embodiment, as the area (WL) of the flat-plate electrode increases, the power applied to the water increases. Simultaneously, as the area (WL) of the flat-plate electrode increases, the power density P_d decreases as shown in the equation 7. In addition, to prevent a high electric field applied to the space between the electrodes and the water from surpassing the dielectric strength voltage of air, the distance d in the horizontal direction is secured to have a certain amount. As in the case of the second embodiment, the width W of the electrode to make the power density maximum and the distance d in the horizontal direction can be determined.

As described above, the high frequency dielectric heater of the present embodiment sandwich the subject to be heated and the electrodes are spaced the distance d therebetween from the facing positions.

Therefore, it is possible to improve the energy efficiency even when not all the electrodes can be disposed on one side of the subject to be heated due to the restrictions of designing.

According to the present disclosure, a high frequency dielectric heater having improved energy efficiency is provided.

The present disclosure is described with reference to the preferred embodiments but the high frequency dielectric heater of the present disclosure is not limited thereto.

Man in the art is able to suitably modify the high frequency dielectric heater of the present disclosure based on known knowledge. In spite of such modifications, if the configuration of the high frequency dielectric heater of the present disclosure is maintained, the modified device is within the scope of the present disclosure.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

What is claimed is:

1. A high frequency dielectric heater comprising:
a high frequency power supply configured to supply a power having a high frequency to heat a subject;
electrodes including a positive electrode and a negative electrode, each electrode being disposed in such a manner that a longitudinal direction of each electrode crosses with a transfer direction of the subject and having a surface at least part of which is parallel to the subject; and
a transfer device configured to transfer the subject.

2. The high frequency dielectric heater according to claim 1, wherein the subject is an article having an image formed by an inkjet method.

3. The high frequency dielectric heater according to claim 1,
wherein each electrode has a flat-plate like form having a pair of flat-plate surfaces having a first area larger than a second area of other surfaces,
wherein the flat-plate surfaces are disposed in parallel with the subject, and
wherein a form of the electrodes, a distance between the positive electrode and the subject and between the negative electrode and the subject is determined in such a manner that a power density defined by the following relation is a maximum, the power density=(the power to be applied to the subject)/(an area of the electrode applying the power).

4. The high frequency dielectric heater according to claim 3, wherein the positive electrode and the negative electrode are spaced a predetermined distance apart from facing positions of the positive electrode and the negative electrode with the subject sandwiched between the positive electrode and the negative electrode.

5. The high frequency dielectric heater according to claim 1, wherein the the positive electrode and the negative electrode are cuboid.
